(19) United States
(12) Patent Application Publication
(10) Pub. No.: US 2026/0279293 A1
(43) Pub. Date: Sep. 17, 2026

(54) SOURCE DRIVER INTEGRATED CIRCUIT AND DISPLAY SYSTEM INCLUDING THE SAME

(71) Applicant: LX SEMICON CO., LTD., Daejeon (KR)

(72) Inventors: Seong Geon KIM, Daejeon (KR); Young Bok KIM, Daejeon (KR); Won KIM, Daejeon (KR); Sang Hyeon LEE, Daejeon (KR)

(73) Assignee: LX SEMICON CO., LTD., Daejeon (KR)

(21) Appl. No.: 19/550,521

(22) Filed: Feb. 26, 2026

(30) Foreign Application Priority Data
Mar. 12, 2025 (KR) 10-2025-0032270

(51) Int. Cl. G09G 3/3291

(52) U.S. Cl. CPC G09G 3/3291; G09G 2300/0408; G09G 2310/0286; G09G 2310/0291; G09G 2310/0297; G09G 2330/025

(57) ABSTRACT

A source driver integrated circuit according to one aspect of the present invention, which may reduce the delay or distortion of a driving signal by reducing the resistance variation between a plurality of routing metals, includes: a first routing metal connecting a first channel driving circuit and a first pad; a second routing metal connecting a second channel driving circuit and a second pad and having a length different from that of the first routing metal; a first resistance variation compensation circuit connected to the first routing metal and having a first compensation resistance value; and a second resistance variation compensation circuit connected to the second routing metal and having a second compensation resistance value different from the first compensation resistance value.

### CROSS-REFERENCE TO RELATED APPLICATIONS

This application claims the benefit of Korean Patent Application No. 10-2025-0032270 filed on Mar. 12, 2025, which is hereby incorporated by reference in its entirety as if fully set forth herein.

### BACKGROUND

### Field of the Invention

The present invention relates to a display system, and more particularly, to a source driver integrated circuit.

### Discussion of the Related Art

As informatization advances, various display systems capable of visualizing information are being developed. Liquid crystal display (LCD) systems, organic light emitting diode (OLED) display systems, plasma display panel (PDP) display systems, and the like are display systems that have been developed or are being developed. These display systems are evolving to adequately display high-resolution images.

A display system includes a display panel including a plurality of pixels defined by a plurality of gate lines and a plurality of data lines, a gate driving circuit for supplying a gate signal to the gate lines, a data driving circuit for supplying a data voltage to the data lines, and a timing controller for controlling the operation of the gate driving circuit and the data driving circuit.

The data driving circuit includes a plurality of source driver integrated circuits (SDICs). The source driver integrated circuit converts a data signal corresponding to a digital image signal received from the timing controller into a data voltage corresponding to an analog image signal and outputs the converted data voltage to the data line.

The source driver integrated circuit includes a driving circuit, a multiplexer circuit, and a plurality of routing metals connecting the multiplexer circuit to a pad. In this case, a difference in length may occur between the plurality of routing metals due to a difference in pad position, and a resistance variation inevitably occurs among the routing metals due to a difference in length between the routing metals. When a resistance variation occurs between the plurality of routing metals, there is a problem of image quality being degraded due to a delay or distortion of a driving signal.

To solve this problem, as shown in FIG. 1, in a typical source driver integrated circuit 10, the lengths of a plurality of routing metals RM connecting each multiplexer circuit 14 to a pad 16 are adjusted to eliminate a resistance variation among the routing metals RM such that all of the routing metals RM are formed to have the same length. However, in the case of the source driver integrated circuit 10 having the structure shown in FIG. 1, there is a problem that the chip size of the source driver integrated circuit 10 increases because a space for forming the routing metals RM is required.

In addition, in the case of the typical source driver integrated circuit 10 shown in FIG. 1, when the length of the routing metals RM is increased to reduce the resistance variation between the routing metals RM, the possibility of overlap between the routing metal RM and other circuits increases, and as a result, output noise may affect other circuits, thereby degrading the performance of the source driver integrated circuit 10.

### SUMMARY

The present invention is directed to providing a source driver integrated circuit capable of reducing a resistance variation among a plurality of routing metals to reduce a delay or distortion of a driving signal, and a display system including the same.

A source driver integrated circuit according to one aspect of the present disclosure for achieving the above-described technical task includes: a first routing metal connecting a first channel driving circuit and a first pad; a second routing metal connecting a second channel driving circuit and a second pad and having a length different from that of the first routing metal; a first resistance variation compensation circuit connected to the first routing metal and having a first compensation resistance value; and a second resistance variation compensation circuit connected to the second routing metal and having a second compensation resistance value different from the first compensation resistance value, wherein a first channel resistance value obtained by adding a first resistance value of the first routing metal and the first compensation resistance value is the same as a second channel resistance value obtained by adding a second resistance value of the second routing metal and the second compensation resistance value.

A display system according to another aspect of the present disclosure for achieving the above-described technical task includes: a display panel; and a source driver integrated circuit configured to drive the display panel, wherein the source driver integrated circuit includes: a first routing metal connecting a first channel driving circuit and a first pad; a second routing metal connecting a second channel driving circuit and a second pad and having a length different from that of the first routing metal; a first resistance variation compensation circuit connected to the first routing metal and having a first compensation resistance value; and a second resistance variation compensation circuit connected to the second routing metal and having a second compensation resistance value different from the first compensation resistance value, wherein a first channel resistance value obtained by adding a first resistance value of the first routing metal and the first compensation resistance value is the same as a second channel resistance value obtained by adding a second resistance value of the second routing metal and the second compensation resistance value.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a view showing the configuration of a typical source driver integrated circuit in which a plurality of routing metals are formed to have the same length;

FIG. 2 is a view showing the configuration of a display system to which a source driver integrated circuit according to one embodiment of the present invention is applied;

FIG. 3 is a view showing the configuration of a source driver integrated circuit including a resistance variation compensation circuit according to one embodiment of the present invention;

FIG. 4 is a view showing the configuration of a source driver integrated circuit when a channel driving circuit is a data voltage output circuit;

FIG. 5 is a view showing the configuration of the data voltage output circuit according to one embodiment of the present invention;

FIG. 6 is a view showing the connection of a sub-pixel and a sensing circuit in an organic light-emitting diode display panel; and

FIG. 7 is a view showing the configuration of a source driver integrated circuit when the channel driving circuit is a sensing circuit.

### DETAILED DESCRIPTION OF THE DISCLOSURE

Like reference numerals refer to like elements throughout. In the following description, when the detailed description of the relevant known function or configuration is determined to unnecessarily obscure the important point of the present disclosure, the detailed description will be omitted.

Advantages and features of the present disclosure, and implementation methods thereof will be clarified through following exemplary aspects described with reference to the accompanying drawings. The present disclosure may, however, be embodied in different forms and should not be construed as limited to the exemplary aspects set forth herein. Rather, these exemplary aspects are provided so that this disclosure will be thorough and complete, and will fully convey the scope of the present disclosure to those skilled in the art. Further, the present disclosure is only defined by scopes of claims.

A shape, a size, a ratio, an angle, and a number disclosed in the drawings for describing exemplary aspects of the present disclosure are merely an example, and thus, the present disclosure is not limited to the illustrated details.

In a case where “include,” “have,” “comprise,” “contain,” “constitute,” “make up of,” “formed of,” and “consist of” described in the present specification are used, another part can be added unless ‘only~’ is used. The terms of a singular form can include plural forms unless referred to the contrary.

In construing an element, the element is construed as including an error range although there is no explicit description.

In describing a position relationship, for example, when a position relation between two parts is described as “on”, “above”, “over”, “below”, “under”, “beside”, “beneath”, “near”, “close to,” “adjacent to”, “on a side of”, “next”, one or more other parts may be disposed between the two parts unless ‘just’ or ‘direct’ is used.

It will be understood that, although the terms “first”, “second” etc. can be used herein to describe various elements, these elements should not be limited by these terms. These terms are only used to distinguish one element from another. Accordingly, a first element mentioned hereinafter could be termed a second element without departing from the scope of the present disclosure.

The term “at least one” should be understood as including any and all combinations of one or more of the associated listed items. For example, the meaning of “at least one of a first item, a second item, and a third item” denotes each of the first item, the second item, and the third item as well as the combination of all items proposed from two or more of the first item, the second item, and the third item.

Features of various exemplary embodiments of the present disclosure can be partially or overall coupled to or combined with each other and can be variously inter-operated or combined with each other and driven technically as those skilled in the art can sufficiently understand. The exemplary embodiments of the present disclosure can be carried out independently from each other, or can be carried out together in co-dependent relationship.

Hereinafter, example embodiments of the present disclosure will be described in detail with reference to the accompanying drawings. Throughout the present disclosure, identical reference numerals refer to substantially identical elements.

Hereinafter, embodiments of the present specification will be described in detail with reference to the accompanying drawings.

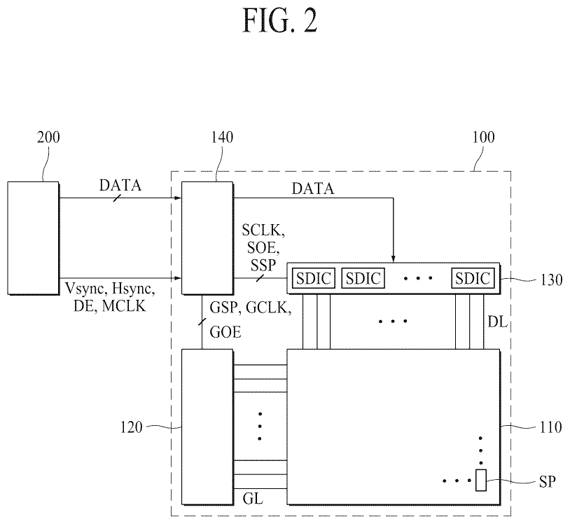

FIG. 2 is a view showing the configuration of a display system to which a source driver integrated circuit according to one embodiment of the present invention is applied. A display system 100 shown in FIG. 2 is an electronic device including the source driver integrated circuit according to the present invention and may be, for example, any of various display systems that use the voltage of a battery or an external power source as an operating voltage.

Referring to FIG. 2, the display system 100 according to the present invention may include a display panel 110 in which a plurality of gate lines GL and a plurality of data lines DL are connected and a plurality of sub-pixels SP are arranged in a matrix form, a gate driving circuit 120 that drives the plurality of gate lines GL, a data driving circuit 130 that supplies a data voltage through the plurality of data lines DL, and a timing controller 140 that controls the gate driving circuit 120 and the data driving circuit 130.

The display panel 110 may display an image based on a scan signal transmitted from the gate driving circuit 120 through the plurality of gate lines GL and a data voltage transmitted from the data driving circuit 130 through the plurality of data lines DL.

In one embodiment, the display panel 110 may be a liquid crystal display panel. When the display panel 110 is a liquid crystal display panel, the display panel 110 may include a liquid crystal layer formed between two substrates and may operate in any known mode, such as a twisted nematic (TN) mode, a vertical alignment (VA) mode, an in-plane switching (IPS) mode, or a fringe field switching (FFS) mode.

In another embodiment, the display panel 110 may be an organic light-emitting diode (OLED) display panel. When the display panel 110 is an organic light-emitting diode display panel, the display panel 110 may be implemented in a top emission manner, a bottom emission manner, a dual emission manner, and the like.

Hereinafter, for convenience of description, the display panel 110 will be described assuming that the display panel 110 is an organic light-emitting diode display panel.

The display panel 110 may have a plurality of pixels arranged in a matrix form, and each of the pixels may include sub-pixels SP of different colors, for example, a white sub-pixel, a red sub-pixel, a green sub-pixel, and a blue sub-pixel, and each of the sub-pixels SP may be defined by the plurality of data lines DL and the plurality of gate lines GL.

One sub-pixel SP may include a thin film transistor (TFT) formed in a region where one data line DL and one gate line GL intersect, an organic light-emitting diode, a storage capacitor that is electrically connected to the organic light-emitting diode to maintain a voltage, and the like. An image may be displayed by controlling the current flowing through an organic light-emitting diode disposed in each of the sub-pixels SP.

The gate driving circuit 120 may be controlled by the timing controller 140. The gate driving circuit 120 may sequentially output scan signals to the plurality of gate lines GL disposed on the display panel 110 to control the driving timing of the plurality of sub-pixels SP.

The gate driving circuit 120 may include at least one gate driver integrated circuit and may be located on only one side or on both sides of the display panel 110 according to a driving method. In another embodiment, the gate driving circuit 120 may be built into a bezel region of the display panel 110 and implemented in the form of a gate in panel (GIP).

The data driving circuit 130 may receive image data DATA from the timing controller 140 and convert the received image data DATA into an analog data voltage. Subsequently, when the data voltage is output to each of the data lines DL in accordance with the timing at which the scan signal is applied through the gate line GL, each of the sub-pixels SP connected to the data line DL may display a light-emitting signal with a brightness corresponding to the data voltage.

The data driving circuit 130 may include at least one source driver integrated circuit SDIC. The source driver integrated circuit SDIC may be connected to a bonding pad of the display panel 110 or may be directly disposed on the display panel 110 using a tape automated bonding (TAB) method or a chip on glass (COG) method.

In one embodiment, each source driver integrated circuit SDIC may be integrated into and disposed on the display panel 110. In addition, each source driver integrated circuit SDIC may be implemented in a chip on film (COF) manner, and in this embodiment, each source driver integrated circuit SDIC may be mounted on a circuit film and electrically connected to the data line DL of the display panel 110 through the circuit film.

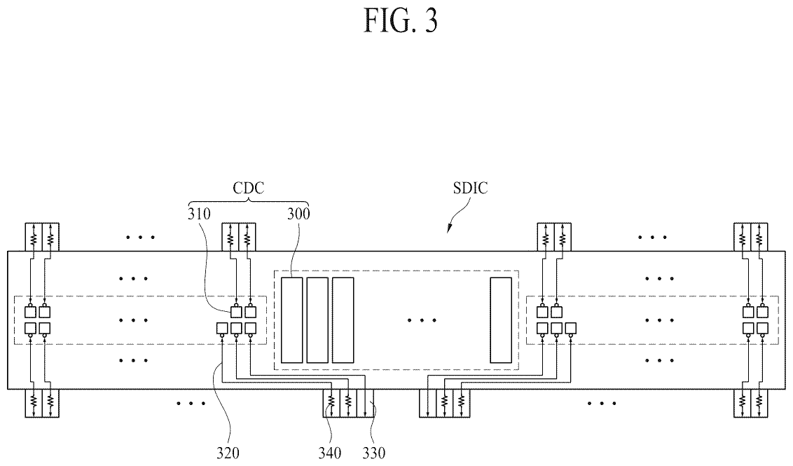

Hereinafter, the source driver integrated circuit according to one embodiment of the present invention will be described in more detail with reference to FIGS. 3 to 7.

FIG. 3 is a view showing the configuration of a source driver integrated circuit including a resistance variation compensation circuit according to one embodiment of the present invention. As shown in FIG. 3, a source driver integrated circuit SDIC according to one embodiment of the present invention may include a plurality of driving circuits 300, a plurality of multiplexer circuits 310, a plurality of routing metals 320, a plurality of pads 330, and a plurality of resistance variation compensation circuits 340.

One driving circuit 300 and one multiplexer circuit 310 may be electrically connected to each other to form one channel driving circuit CDC. According to this embodiment, the source driver integrated circuit SDIC may include a plurality of channel driving circuits CDC.

In one embodiment, the channel driving circuit CDC may be a data voltage output circuit that supplies a data voltage to the data line DL. When the channel driving circuit CDC is a data voltage output circuit, the channel driving circuit CDC may respond to a data control signal supplied from the timing controller 140 when driving a display, convert the input image data DATA into an analog data voltage, and supply the converted analog voltage to a corresponding data line DL.

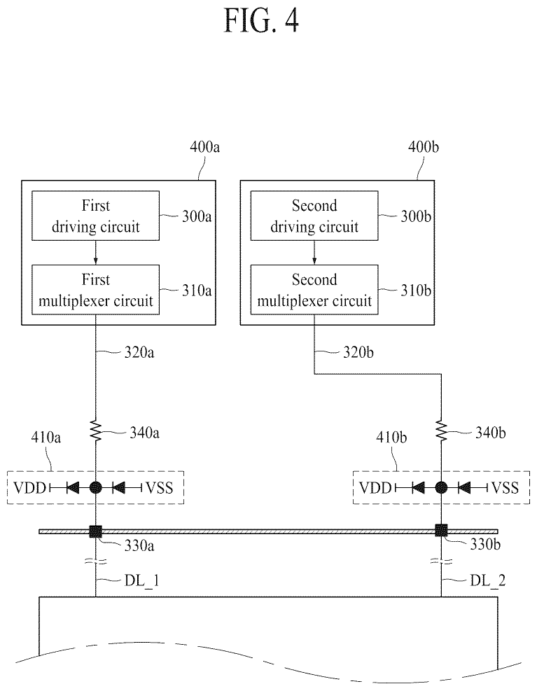

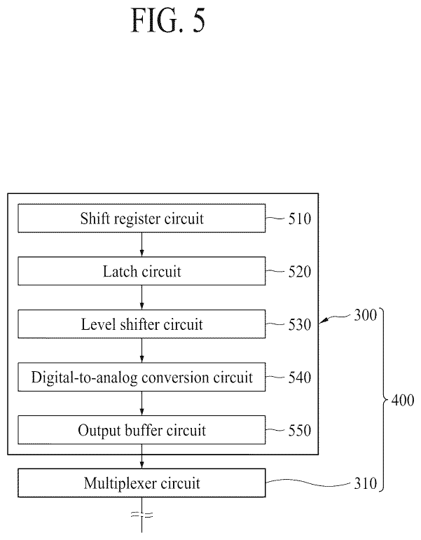

Hereinafter, an embodiment in which the channel driving circuit CDC is a data voltage output circuit will be described in detail with further reference to FIGS. 4 and 5. FIG. 4 is a view showing the configuration of a source driver integrated circuit when the channel driving circuit is a data voltage output circuit, and FIG. 5 is a view showing the configuration of the data voltage output circuit according to one embodiment of the present invention.

Since the configuration and driving method of each data voltage output circuit 400 are the same, hereinafter, for convenience of explanation, the configuration and operation of the source driver integrated circuit SDIC will be described based on a first data voltage output circuit 400a and a second data voltage output circuit 400b among the plurality of data voltage output circuits.

As shown in FIG. 4, the first data voltage output circuit 400a may be connected to a first pad 330a through a first routing metal 320a. The first data voltage output circuit 400a may include a first driving circuit 300a and a first multiplexer circuit 310a. In one embodiment, the first driving circuit 300a may be disposed in a central portion of the source driver integrated circuit SDIC, and the first multiplexer circuit 310a may be disposed on one side of the first driving circuit 300a.

The second data voltage output circuit 400b may be connected to a second pad 330b through a second routing metal 320b. The second data voltage output circuit 400b may include a second driving circuit 300b and a second multiplexer circuit 310b. In one embodiment, the second driving circuit 300b may be disposed in the central portion of the source driver integrated circuit SDIC, and the second multiplexer circuit 310b may be disposed on one side of the second driving circuit 300b.

The first driving circuit 300a and the second driving circuit 300b may each include a shift register circuit 510, a latch circuit 520, a level shifter circuit 530, a digital-to-analog conversion circuit 540, and an output buffer circuit 550, as shown in FIG. 5, to output data voltages corresponding to image data to data lines DL_1 and DL_2.

The shift register circuit 510 may include a plurality of shift registers (not shown). Each of the shift registers included in the shift register circuit 510 may sequentially shift source start pulses SSP using a source sampling clock SCLK to generate a sampling signal and input the sampling signal to the latch circuit 520.

The latch circuit 520 may latch image data in predetermined units in response to the sampling signal and then output the latched image data to the level shifter circuit 530. To this end, the latch circuit 520 may include a first latch circuit (not shown) and a second latch circuit (not shown). The first latch circuit may include a plurality of sampling latches (not shown). The plurality of sampling latches included in the first latch circuit may sample serially input image data in synchronization with a sampling signal input from the shift register circuit 510 connected to each of the sampling latches.

The second latch circuit may include a plurality of holding latches (not shown). The holding latches included in the second latch circuit may latch image data output from the first latch circuit for each channel and output the latched image data to the level shifter circuit 530.

The level shifter circuit 530 may include a plurality of level shifters (not shown). Each of the level shifters included in the level shifter circuit 530 may shift the voltage level of image data output from the second latch circuit to a predetermined voltage level.

The digital-to-analog conversion circuit 540 may convert image data for each channel, whose voltage level has been shifted, into an analog data voltage using a reference gamma voltage generated by a gamma voltage generation circuit (not shown).

The output buffer circuit 550 may include a plurality of output buffers (not shown). Each of the output buffers included in the output buffer circuit 550 may buffer the data voltage for each channel converted by the digital-to-analog conversion circuit 540 and output the data voltage to the multiplexer circuit 310.

Referring again to FIG. 4, the first multiplexer circuit 310a may output the data voltage output through the output buffer circuit 550 included in the first driving circuit 300a to the sub-pixel SP of the display panel 110 through the first data line DL_1. In one embodiment, the first multiplexer circuit 310a may include a plurality of switching elements (not shown), and the switching elements may be controlled to select the first data line DL_1 on which the data voltage is to be output.

The second multiplexer circuit 310b may output the data voltage output through the output buffer circuit 550 included in the second driving circuit 300b to the sub-pixel SP of the display panel 110 through the second data line DL_2. In one embodiment, the second multiplexer circuit 310b may include the plurality of switching elements (not shown) and control the switching elements to select the second data line DL_2 on which the data voltage is to be output.

The first routing metal 320a may electrically connect the first multiplexer circuit 310a to the first pad 330a, and the second routing metal 320b may connect the second multiplexer circuit 310b to the second pad 330b. Since the first multiplexer circuit 310a is disposed close to the first pad 330a and the second multiplexer circuit 310b is disposed far from the second pad 330b, the first routing metal 320a electrically connecting the first multiplexer circuit 310a and the first pad 330a may be formed to have a shorter length than the second routing metal 320b electrically connecting the second multiplexer circuit 310b and the second pad 330b.

Accordingly, since the first routing metal 320a and the second routing metal 320b have different lengths, the first resistance value of the first routing metal 320a and the second resistance value of the second routing metal 320b are inevitably different. Additionally, since the length of the second routing metal 320b is longer than the length of the first routing metal 320a, a second resistance value of the second routing metal 320b is inevitably greater than a first resistance value of the first routing metal 320a.

Accordingly, the source driver integrated circuit SDIC according to the present invention may include a first resistance variation compensation circuit 340a connected to the first routing metal 320a and a second resistance variation compensation circuit 340b connected to the second routing metal 320b to improve the resistance variation between the first routing metal 320a and the second routing metal 320b that have different lengths.

The first resistance variation compensation circuit 340a may be connected to the first routing metal 320a and may be formed to have a first compensation resistance value.

The second resistance variation compensation circuit 340b may be connected to the second routing metal 320b and may be formed to have a second compensation resistance value.

In this case, the first compensation resistance value and the second compensation resistance value are determined so that a first channel resistance value, which is a sum of the first compensation resistance value and the first resistance value of the first routing metal 320a, is equal to a second channel resistance value, which is a sum of the second compensation resistance value and the second resistance value of the second routing metal 320b.

In one embodiment, the first resistance variation compensation circuit 340a may be implemented as a first resistor having a first compensation resistance value, and a second resistance variation compensation circuit 340b may be implemented as a second resistor having a second compensation resistance value. In this case, the first compensation resistance value and the second compensation resistance value may be defined by the following Expression 1.

$$Rsp * ( Rsp\_LengthN / Rsp\_Width ) \qquad [ Expression 1 ]$$

In Expression 1, Rsp represents a resistivity value of the first resistor and the second resistor, Rsp_LengthN represents the length of an Nth resistor, and Rsp_Width represents the widths of the first resistor and the second resistor. Since the first resistor and the second resistor are formed of the same material and have the same width, Rsp and Rsp_Width are constant for each resistor.

Meanwhile, the first resistance value of the first routing metal 320a and the second resistance value of the second routing metal 320b may be defined by the following Expression 2.

$$Rsm * ( Rsm\_LengthN / Rsm\_Width ) \qquad [ Expression 2 ]$$

In Expression 2, Rsm represents a resistivity value of the first routing metal 320a and the second routing metal 320b, Rsm_LengthN represents the length of the Nth routing metal, and Rsm_Width represents the widths of the first routing metal 320a and the second routing metal 320b. Since the first routing metal 320a and the second routing metal 320b are formed of the same material and have the same width, Rsm and Rsm_Width are constant for each routing metal.

In this case, since the first routing metal 320a and the second routing metal 320b have different lengths, the first resistance value of the first routing metal 320a and the second resistance value of the second routing metal 320b may be different values.

According to the above, the first channel resistance value may be determined according to the following Expression 3, and the second channel resistance value may be determined according to the following Expression 4.

$$Rsm * ( Rsm\_Length1 / Rsm\_Width ) + Rsp * ( Rsp\_Length1 / Rsp\_Width ) \qquad [ Expression 3 ]$$

$$Rsm * ( Rsm\_Length2 / Rsm\_Width ) + Rsp * ( Rsp\_Length2 / Rsp\_Width ) \qquad [ Expression 4 ]$$

As described above, since the first channel resistance value and the second channel resistance value need to be the same and the first resistance value of the first routing metal 320a and the second resistance value of the second routing metal 320b are different, the first compensation resistance value and the second compensation resistance value are inevitably different. For example, when the first resistance value of the first routing metal 320a is smaller than the second resistance value of the second routing metal 320b, the first compensation resistance value may be set to be larger than the second compensation resistance value.

According to the present invention, in order to improve the resistance variation between the first routing metal 320a and the second routing metal 320b formed to have different lengths, instead of making the first routing metal 320a and the second routing metal 320b have the same length, the lengths of the first routing metal 320a and the second routing metal 320b are maintained as is. However, to ensure that the total resistance values (that is, channel resistance values) of the first routing metal 320a and the second routing metal 320b are the same, the first resistance variation compensation circuit 340a having a first compensation resistance value may be added to the first routing metal 320a, and the second resistance variation compensation circuit 340b having a second compensation resistance value different from the first compensation resistance value may be added to the second routing metal 320b.

As described above, according to the present invention, the addition of the resistance variation compensation circuit 340 may eliminate the resistance variation caused by a difference in length between the routing metals 320, thereby reducing the delay or distortion of a driving signal.

In addition, according to the present invention, there is an effect that the chip size of the source driver integrated circuit SDIC is reduced because there is no need to increase the length of the routing metal 320 to improve the resistance variation of each of the routing metals 320.

In addition, when the length of the routing metal needs to be increased to improve resistance variations as in the related art, the second routing metal 320b needs to be formed to pass through a plurality of stacked layers to secure the length of the routing metal. However, according to the present invention, since there is no need to increase the length of the routing metal to improve resistance variations, the routing metal 320 may be formed using only the metal on the same layer among the plurality of stacked layers (for example, the uppermost metal), thereby increasing the degree of freedom in chip design.

Meanwhile, as shown in FIG. 4, the source driver integrated circuit SDIC according to the present invention may further include a first electrostatic discharge (ESD) diode 410a connected to the first routing metal 320a and a second ESD diode 410b connected to the second routing metal 320b. According to this embodiment, the first resistor constituting the first resistance variation compensation circuit 340a and the second resistor constituting the second resistance variation compensation circuit 340b may simultaneously function as ESD resistors. In this case, the first resistor and the second resistor may be configured to include the same resistance value corresponding to the ESD resistor.

The first ESD diode 410a may be provided to be connected to a high-potential driving voltage VDD or a low-potential driving voltage VSS at a location between the first resistance variation compensation circuit 340a and the first pad 330a. The first ESD diode 410a may be a circuit element that prevents excessive current from flowing into the chip from the outside. When a surge current is applied from outside the chip, the surge current may be allowed to flow to the first ESD diode 410a, which has a relatively low resistance compared to the first resistance variation compensation circuit 340a, thereby protecting the components inside the chip.

The second ESD diode 410b may be provided to be connected to the high-potential driving voltage VDD or the low-potential driving voltage VSS at a location between the second resistance variation compensation circuit 340b and the second pad 330b. The second ESD diode 410b may be a circuit element that prevents excessive current from flowing into the chip from the outside. When a surge current is applied from outside the chip, the surge current may be allowed to flow to the second ESD diode 410b, which has a relatively low resistance compared to the second resistance variation compensation circuit 340b, thereby protecting the components inside the chip.

In the above-described embodiment, the first resistance variation compensation circuit 340a and the second resistance variation compensation circuit 340b are described as simultaneously functioning as ESD resistors. However, in other embodiments, the source driver integrated circuit SDIC may additionally include a separate ESD resistor for each channel. In this case, the ESD resistor included in each channel may have the same resistance value.

Meanwhile, in the above-described embodiment, it was described that the channel driving circuit CDC is a data voltage output circuit 400. In another embodiment, the channel driving circuit CDC may be a sensing circuit. That is, one driving circuit 300 and one multiplexer circuit 310 that are shown in FIG. 3 are electrically connected to each other to form one sensing circuit. According to this embodiment, the source driver integrated circuit SDIC may include a plurality of data voltage output circuits 400 and a plurality of sensing circuits.

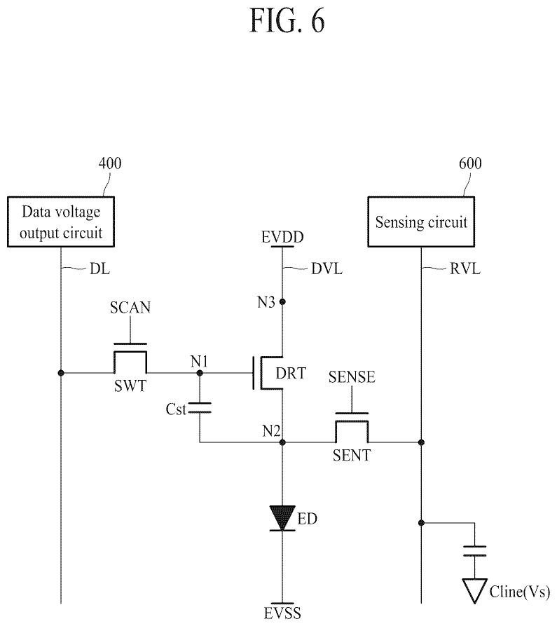

Hereinafter, referring to FIG. 6, the configuration of the source driver integrated circuit is described in detail when the channel driving circuit CDC is a sensing circuit. FIG. 6 is a view showing the connection of the sub-pixel and the sensing circuit of the organic light-emitting diode display panel 110.

Referring to FIG. 6, the sub-pixel SP may include a driving transistor DRT, a switching transistor SWT, a sensing transistor SENT, a storage capacitor Cst, and an organic light-emitting diode ED. The data voltage output circuit 400 may be connected to the sub-pixel SP through the data line DL, and a sensing circuit 600 may be connected to the sub-pixel SP through a reference line RVL.

The driving transistor DRT may include a first node N1, a second node N2, and a third node N3. The first node N1 of the driving transistor DRT may be a gate node to which a data voltage Vdata is applied from the data voltage output circuit 400 through the data line DL when the switching transistor SWT is turned on. The second node N2 of the driving transistor DRT may be electrically connected to an anode electrode of the organic light-emitting diode ED and may be a source node or a drain node. The third node N3 of the driving transistor DRT may be electrically connected to a driving voltage line DVL to which a driving voltage EVDD is applied and may be a drain node or a source node.

In this case, during a display driving period, the driving voltage EVDD required for displaying an image may be supplied to the driving voltage line DVL.

The switching transistor SWT may be electrically connected between the first node N1 of the driving transistor DRT and the data line DL, and the gate line GL may be connected to the gate node and operate according to a scan signal SCAN supplied through the gate line GL. In addition, when the switching transistor SWT is turned on, the data voltage Vdata supplied through the data line DL is transmitted to the gate node of the driving transistor DRT, thereby controlling the operation of the driving transistor DRT.

The sensing transistor SENT may be electrically connected between the second node N2 of the driving transistor DRT and the reference line RVL, and may operate according to a sense signal SENSE supplied through a gate line GL connected to a gate node thereof. When the sensing transistor SENT is turned on, a sensing reference voltage VSEN supplied through the reference line RVL may be transmitted to the second node N2 of the driving transistor DRT.

That is, when the switching transistor SWT and the sensing transistor SENT are controlled, the voltage of the first node N1 and the voltage of the second node N2 of the driving transistor DRT may be controlled, thereby allowing current to be supplied to drive the organic light-emitting diode ED.

The gate nodes of the switching transistor SWT and the sensing transistor SENT may be connected in common to a single gate line GL or may be connected to different gate lines GL. FIG. 6 shows an example of a structure in which the switching transistor SWT and the sensing transistor SENT are connected to different gate lines GL. In this case, the switching transistor SWT and the sensing transistor SENT may be independently controlled by the scan signal SCAN and the sense signal SENSE that are transmitted through different gate lines GL.

On the other hand, when the switching transistor SWT and the sensing transistor SENT are connected to one gate line GL, the switching transistor SWT and the sensing transistor SENT may be simultaneously controlled by the scan signal SCAN or the sense signal SENSE that is transmitted through one gate line GL, and the aperture ratio of the sub-pixel SP may increase.

Meanwhile, the transistors disposed in the sub-pixel SP may include not only n-type transistors but also p-type transistors, and FIG. 6 shows an example of a case in which the transistors include n-type transistors.

The storage capacitor Cst may be electrically connected between the first node N1 and the second node N2 of the driving transistor DRT and maintain the data voltage Vdata for one frame.

The storage capacitor Cst may be connected between the first node N1 and the third node N3 of the driving transistor DRT according to the type of driving transistor DRT. The anode electrode of the organic light-emitting diode ED may be electrically connected to the second node N2 of the driving transistor DRT, and a base voltage EVSS may be applied to a cathode electrode of the organic light-emitting diode ED.

Here, the base voltage EVSS may be the ground voltage or a voltage higher or lower than the ground voltage. Additionally, the base voltage EVSS may vary according to the driving state, and for example, the base voltage EVSS at the display driving time and the base voltage EVSS at the sensing driving time may be set differently.

The structure of the sub-pixel SP described above as an example is a 3 transistor (T) 1 capacitor (C) structure and is only an example for illustrative purposes. The sub-pixel SP may further include one or more additional transistors or, in some cases, may further include one or more additional capacitors. Each of the plurality of sub-pixels SP may be formed to have the same structure, and some of the plurality of sub-pixels SP may be formed to have different structures.

The sensing circuit 600 may measure the current flowing due to the voltage charged in the storage capacitor Cst during the characteristic value sensing period of the driving transistor DRT to sense the characteristic value of the driving transistor DRT, for example, a threshold voltage or mobility, and this is called current sensing.

That is, the sensing circuit 600 may detect the characteristic value of the driving transistor DRT in the sub-pixel SP or a change in the characteristic value by measuring the current flowing due to the voltage charged in the storage capacitor Cst during the characteristic value sensing period of the driving transistor DRT.

In this case, since the reference line RVL not only transmits the sensing reference voltage VSEN, but also serves as a sensing line for sensing the characteristic value of the driving transistor DRT in the sub-pixel SP, the reference line RVL may also be called a sensing line.

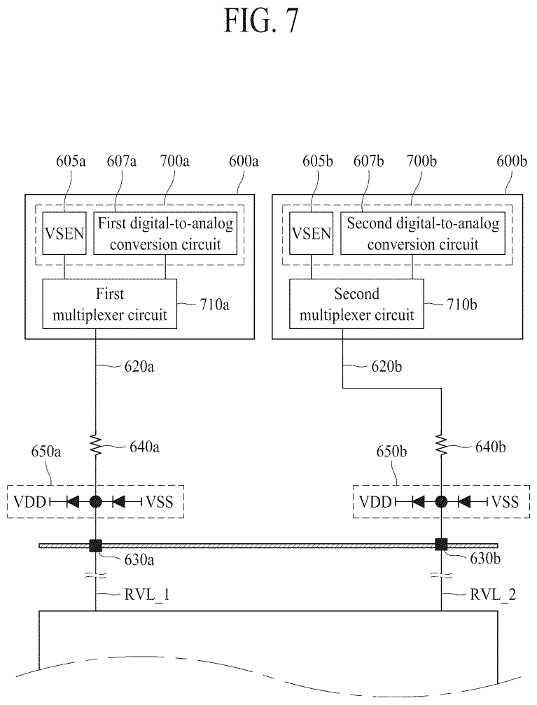

Hereinafter, an embodiment in which the channel driving circuit CDC is a sensing circuit 600 will be described in more detail with additional reference to FIG. 7. FIG. 7 is a view showing the configuration of the source driver integrated circuit when the channel driving circuit is a sensing circuit. Since the configuration and driving method of each sensing circuit 600 are the same, hereinafter, for convenience of description, the configuration and operation of the source driver integrated circuit SDIC will be described based on a first sensing circuit 600a and a second sensing circuit 600b.

The first sensing circuit 600a may be connected to a first reference line RVL_1, supply the sensing reference voltage VSEN to the first reference line RVL_1, and sense the voltage of the first reference line RVL_1. When the first sensing circuit 600a generates sensing data corresponding to the sensed voltage and transmits the generated sensing data to the timing controller 140, the timing controller 140 may compare the data received from the first sensing circuit 600a with a pre-stored reference value to compensate for the variation in the characteristic value of the driving transistor DRT of the sub-pixel to which the first sensing circuit 600a is connected.

The second sensing circuit 600b may be connected to a second reference line RVL_2, supply the sensing reference voltage VSEN to the second reference line RVL_2, and sense the voltage of the second reference line RVL_2. When the second sensing circuit 600b generates sensing data corresponding to the sensed voltage and transmits the generated sensing data to the timing controller 140, the timing controller 140 may compare the data received from the second sensing circuit 600b with a pre-stored reference value to compensate for the variation in the characteristic value of the driving transistor DRT of the sub-pixel to which the second sensing circuit 600b is connected.

According to this embodiment, the characteristic value or change in the characteristic value of the driving transistor DRT may be reflected as the voltage (for example, Vdata-Vth) of the second node N2 of the driving transistor DRT as shown in FIG. 6. The voltage of the second node N2 of the driving transistor DRT may correspond to the voltage of the reference line RVL shown in FIG. 6 when the sensing transistor SENT is turned on. In addition, a line capacitor Cline of the reference line RVL shown in FIG. 6 may be charged by the voltage of the second node N2 of the driving transistor DRT, and the reference line RVL may have a voltage corresponding to the voltage of the second node N2 of the driving transistor DRT by the sensing voltage Vs charged in the line capacitor Cline.

In one embodiment, the section in which the first sensing circuit 600a and the second sensing circuit 600b sense the characteristic value (threshold voltage and mobility) of the driving transistor DRT may be performed before display driving begins after a power-on signal is generated, after the power-off signal of the display system 100 is generated, or in real time during display driving.

In order to perform the sensing function as described above, as shown in FIG. 7, the first sensing circuit 600a may include a first driving circuit 700a and a first multiplexer circuit 710a, and the second sensing circuit 600b may include a second driving circuit 700b and a second multiplexer circuit 710b. Additionally, the first driving circuit 700a may include a first reference voltage application node 605a and a first analog-to-digital conversion circuit 607a, and the second driving circuit 700b may include a second reference voltage application node 605b and a second analog-to-digital conversion circuit 607b.

The first reference voltage application node 605a may apply the sensing reference voltage VSEN to the first reference line RVL_1 to sense the characteristic value of the sub-pixel connected to the first reference line RVL_1.

The first analog-to-digital conversion circuit 607a may receive the sensing voltage sensed from the sub-pixel through the first reference line RVL_1 and convert the received sensing voltage into digital sensing data. That is, the first analog-to-digital conversion circuit 607a may measure the voltage of the first reference line RVL_1 corresponding to the voltage of the second node N2 of the driving transistor DRT and convert the measured voltage into a digital value.

The first multiplexer circuit 710a may selectively connect the first reference voltage application node 605a and the first analog-to-digital conversion circuit 607a to the first reference line RVL_1. To this end, the first multiplexer circuit 710a may include at least one position circuit (not shown) for sensing a characteristic value.

More specifically, the first multiplexer circuit 710a may include a first sensing reference switch (not shown) that controls the connection between the first reference line RVL_1 and the first reference voltage application node 605a, and a first sampling switch (not shown) that controls the connection between the first reference line RVL_1 and the first analog-to-digital conversion circuit 607a. Here, the first sensing reference switch is a switch that controls characteristic value sensing driving, and the sensing reference voltage VSEN may be supplied to the first reference line RVL_1 by the first sensing reference switch.

Meanwhile, the first sensing reference switch may function as a reference switch for display driving. In this case, the first sensing reference switch may supply a reference voltage for display driving having the same voltage value as the sensing reference voltage VSEN or may supply a reference voltage for display driving having a voltage value different from the sensing reference voltage VSEN.

The second reference voltage application node 605b may apply a sensing reference voltage VSEN to the second reference line RVL_2 to sense the characteristic value of the driving transistor of the sub-pixel connected to the second reference line RVL_2.

The second analog-to-digital conversion circuit 607b may receive the sensing voltage sensed from the sub-pixel through the second reference line RVL_2 and convert the received sensing voltage into digital sensing data. That is, the second analog-to-digital conversion circuit 607b may measure the voltage of the second reference line RVL_2 corresponding to the voltage of the second node N2 of the driving transistor DRT and convert the measured voltage into a digital value.

The second multiplexer circuit 710b may selectively connect the second reference voltage application node 605b and the second analog-to-digital conversion circuit 607b to the second reference line RVL_2. To this end, the second multiplexer circuit 710b may include at least one position circuit (not shown) for characteristic value sensing.

More specifically, the second multiplexer circuit 710b may include a second sensing reference switch (not shown) that controls the connection between the second reference line RVL_2 and the second reference voltage application node 605b and a second sampling switch (not shown) that controls the connection between the second reference line RVL_2 and the second analog-to-digital conversion circuit 607b. Here, the second sensing reference switch is a switch that controls characteristic value sensing driving, and the sensing reference voltage VSEN may be supplied to the second reference line RVL_2 by the second sensing reference switch.

Meanwhile, the second sensing reference switch may also function as a reference switch for display driving. In this case, the second sensing reference switch may supply a reference voltage for display driving having the same voltage value as the sensing reference voltage VSEN or may supply a reference voltage for display driving having a different voltage value from the sensing reference voltage VSEN.

A first routing metal 620a may electrically connect the first multiplexer circuit 710a to a first pad 630a, and a second routing metal 620b may connect the second multiplexer circuit 710b to a second pad 630b. Since the first multiplexer circuit 710a is disposed close to the first pad 630a and the second multiplexer circuit 710b is disposed far from the second pad 630b, the first routing metal 620a electrically connecting the first multiplexer circuit 710a and the first pad 630a may be formed to have a shorter length than the second routing metal 620b electrically connecting the second multiplexer circuit 710b and the second pad 630b.

Since the first routing metal 620a and the second routing metal 620b have different lengths, a first resistance value of the first routing metal 620a and a second resistance value of the second routing metal 620b are inevitably different. In addition, since the length of the second routing metal 620b is longer than the length of the first routing metal 620a, the second resistance value of the second routing metal 620b is inevitably greater than the first resistance value of the first routing metal 620a.

Accordingly, the present invention may include a first resistance variation compensation circuit 640a connected to the first routing metal 620a and a second resistance variation compensation circuit 640b connected to the second routing metal 620b to improve the resistance variation between the first routing metal 620a and the second routing metal 620b that have different lengths.

The first resistance variation compensation circuit 640a may be connected to the first routing metal 620a and may be formed to have a first compensation resistance value. The second resistance variation compensation circuit 640b may be connected to the second routing metal 620b and may be formed to have a second compensation resistance value.

Since the first resistance variation compensation circuit 640a and the second resistance variation compensation circuit 640b are the same as the first resistance variation compensation circuit 340a and the second resistance variation compensation circuit 340b shown in FIG. 4, a detailed description thereof is omitted.

Meanwhile, a source driver integrated circuit SDIC according to another embodiment of the present invention may further include a first ESD diode 650a connected to a first routing metal 620a and a second ESD diode 650b connected to a second routing metal 620b, as shown in FIG. 7. Since the first ESD diode 650a and the second ESD diode 650b are the same as the first ESD diode 410a and the second ESD diode 410b shown in FIG. 4, a detailed description thereof is omitted.

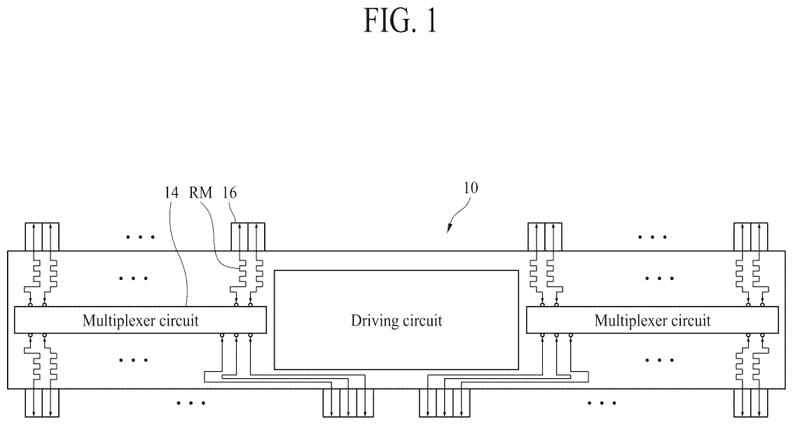

Referring again to FIG. 1, the timing controller 140 may supply a control signal to the gate driving circuit 120 and the data driving circuit 130 and control the operation of the gate driving circuit 120 and the data driving circuit 130. That is, the timing controller 140 may control the gate driving circuit 120 to output a scan signal according to the timing implemented in each frame and transmit image data DATA received from the outside to the data driving circuit 130, thereby controlling the data driving circuit 130 to output a data voltage corresponding to the image data DATA to the data line DL.

In this case, the timing controller 140 may receive a timing signal including a vertical synchronization signal Vsync, a horizontal synchronization signal Hsync, a data enable signal DE, a main clock MCLK, and the like from an external host system 200, along with the image data DATA.

The host system 200 may be any one of a television (TV) system, a set-top box, a navigation system, a personal computer (PC), a home theater system, a mobile device, and a wearable device.

Accordingly, the timing controller 140 may generate a control signal using the timing signal received from the host system 200 and transmit the generated control signal to the gate driving circuit 120 and the data driving circuit 130.

For example, the timing controller 140 may output a gate control signal including a gate start pulse GSP, a gate clock GCLK, a gate output enable signal GOE, and the like to the gate driving circuit 120 to control the gate driving circuit 120.

Here, the gate start pulse GSP may control the timing at which at least one gate driver integrated circuit constituting the gate driving circuit 120 starts to operate. In addition, the gate clock GCLK is a clock signal commonly input to the at least one gate driver integrated circuit and may control the shift timing of a scan signal. In addition, the gate output enable signal GOE may specify timing information of the at least one gate driver integrated circuit.

In addition, the timing controller 140 may output a data control signal including a source start pulse SSP, a source sampling clock SCLK, a source output enable signal SOE, and the like to the data driving circuit 130 to control the data driving circuit 130. Here, the source start pulse SSP may control the timing at which at least one source driver integrated circuit SDIC constituting the data driving circuit starts data sampling. The source sampling clock SCLK is a clock signal that controls the timing of data sampling in the at least one source driver integrated circuit SDIC. The source output enable signal SOE may control the output timing of the at least one source driver integrated circuit SDIC.

In addition, the timing controller 140 may compensate for the variation in the characteristic value of a driving transistor of a sub-pixel to which a sensing circuit 600 is connected by comparing the sensing data received from the sensing circuit 600 with a pre-stored reference value.

The display system 100 may further include a power management integrated circuit (PMIC) that supplies various voltages or currents to the display panel 110, the gate driving circuit 120, the data driving circuit 130, and the like or controls various voltages or currents to be supplied.

According to the present invention, to compensate for a resistance variation between a first routing metal and a second routing metal that have different lengths, a first resistance variation compensation circuit having a first compensation resistance value is connected to the first routing metal, and a second resistance variation compensation circuit having a second compensation resistance value is connected to the second routing metal, and the first and second compensation resistance values are determined such that a first channel resistance value obtained by adding the first compensation resistance value and a first resistance value of the first routing metal is the same as a second channel resistance value obtained by adding the second compensation resistance value and a second resistance value of the second routing metal, thereby eliminating a resistance variation caused by a difference in length between the routing metals and reducing a delay or distortion of a driving signal.

In addition, according to the present invention, since it is not necessary to increase the length of the routing metal to improve resistance variations, the chip size of the source driver integrated circuit can be reduced.

In addition, according to the present invention, since it is not necessary to increase the length of the routing metal to improve resistance variations, a routing metal can be formed using only metal on the same layer without forming the routing metal to pass through a plurality of layers to secure the length of the routing metal, thereby increasing the degree of freedom in chip design.

A person skilled in the art to which the present invention pertains will understand that the present invention described above may be implemented in other specific forms without changing its technical idea or essential characteristics.

Therefore, it should be understood that the embodiments described above are exemplary in all respects and not limiting. The scope of the present invention is indicated by the claims described below rather than the detailed description, and all changes or modifications derived from the meaning and scope of the claims and their equivalent concepts should be interpreted as being included in the scope of the present invention.

What is claimed is:

1. A source driver integrated circuit comprising:
a first routing metal connecting a first channel driving circuit and a first pad;
a second routing metal connecting a second channel driving circuit and a second pad and having a length different from that of the first routing metal;
a first resistance variation compensation circuit connected to the first routing metal and having a first compensation resistance value; and
a second resistance variation compensation circuit connected to the second routing metal and having a second compensation resistance value different from the first compensation resistance value,
wherein a first channel resistance value obtained by adding a first resistance value of the first routing metal and the first compensation resistance value is the same as a second channel resistance value obtained by adding a second resistance value of the second routing metal and the second compensation resistance value.

2. The source driver integrated circuit of claim 1, wherein the first channel driving circuit and the second channel driving circuit are data voltage output circuits configured to supply a data voltage corresponding to image data to at least one data line.

3. The source driver integrated circuit of claim 1, wherein each of the first channel driving circuit and the second channel driving circuit includes:
a shift register circuit configured to sequentially shift a source start pulse transmitted from a timing controller according to a source sampling clock to generate a sampling signal;
a latch circuit configured to sequentially sample and latch image data output from the timing controller in predetermined units in response to the sampling signal output from the shift register circuit;
a digital-to-analog conversion circuit configured to convert the image data sampled by the latch circuit into a data voltage in an analog form;
an output buffer circuit configured to buffer the data voltage output from the digital-to-analog conversion circuit; and
a multiplexer circuit configured to selectively output the data voltage buffered by the output buffer circuit to any one of a plurality of data lines.

4. The source driver integrated circuit of claim 1, further comprising a first electrostatic discharge (ESD) diode configured to prevent an inflow of excessive current,
wherein the first resistance variation compensation circuit is connected between the first channel driving circuit and the first ESD diode.

5. The source driver integrated circuit of claim 1, further comprising a second electrostatic discharge (ESD) diode configured to prevent an inflow of excessive current,
wherein the second resistance variation compensation circuit is connected between the second channel driving circuit and the second ESD diode.

6. The source driver integrated circuit of claim 1, wherein the first resistance variation compensation circuit and the second resistance variation compensation circuit further include an electrostatic discharge (ESD) resistor having the same resistance value.

7. The source driver integrated circuit of claim 1, wherein the first routing metal and the second routing metal are formed using a metal on the same layer among a plurality of stacked layers.

8. The source driver integrated circuit of claim 1, wherein the source driver integrated circuit drives an organic light-emitting diode display panel including a plurality of sub-pixels in which organic light-emitting diodes are disposed.

9. The source driver integrated circuit of claim 8, wherein the first channel driving circuit and the second channel driving circuit are sensing circuits configured to sense characteristics of the plurality of sub-pixels included in the organic light-emitting diode display panel.

10. The source driver integrated circuit of claim 8, wherein each of the first channel driving circuit and the second channel driving circuit includes:
a reference voltage application node configured to apply a sensing reference voltage for sensing characteristics of the sub-pixel to a reference line connected to the sub-pixel;
an analog-to-digital conversion circuit configured to receive a sensing voltage sensed from the sub-pixel through the reference line and convert the sensing voltage into digital sensing data; and
a multiplexer circuit configured to selectively connect the reference voltage application node and the analog-to-digital conversion circuit to the reference line.

11. A display system comprising:
a display panel; and
a source driver integrated circuit configured to drive the display panel,
wherein the source driver integrated circuit includes:
a first routing metal connecting a first channel driving circuit and a first pad;
a second routing metal connecting a second channel driving circuit and a second pad and having a length different from that of the first routing metal;
a first resistance variation compensation circuit connected to the first routing metal and having a first compensation resistance value; and
a second resistance variation compensation circuit connected to the second routing metal and having a second compensation resistance value different from the first compensation resistance value,
wherein a first channel resistance value obtained by adding a first resistance value of the first routing metal and the first compensation resistance value is the same as a second channel resistance value obtained by adding a second resistance value of the second routing metal and the second compensation resistance value.

12. The display system of claim 11, wherein the first channel driving circuit and the second channel driving circuit are data voltage output circuits configured to supply a data voltage corresponding to image data to a corresponding data line.

13. The display system of claim 11, wherein each of the first channel driving circuit and the second channel driving circuit includes:
a shift register circuit configured to sequentially shift a source start pulse transmitted from a timing controller according to a source sampling clock to generate a sampling signal;
a latch circuit configured to sequentially sample and latch image data output from the timing controller in predetermined units in response to the sampling signal output from the shift register circuit;
a digital-to-analog conversion circuit configured to convert the image data sampled by the latch circuit into a data voltage in an analog form;
an output buffer circuit configured to buffer the data voltage output from the digital-to-analog conversion circuit; and
a multiplexer circuit configured to selectively output the data voltage buffered by the output buffer circuit to any one of a plurality of data lines.

14. The display system of claim 11, wherein the display panel is an organic light-emitting diode display panel including a plurality of sub-pixels in which organic light-emitting diodes are disposed.

15. The display system of claim 14, wherein the first channel driving circuit and the second channel driving circuit are sensing circuits configured to sense characteristics of the plurality of sub-pixels included in the organic light-emitting diode display panel.

16. The display system of claim 14, wherein each of the first channel driving circuit and the second channel driving circuit includes:
a reference voltage application node configured to apply a sensing reference voltage for sensing characteristics of the sub-pixel to a reference line connected to the sub-pixel;
an analog-to-digital conversion circuit configured to receive a sensing voltage sensed from the sub-pixel through the reference line and convert the sensing voltage into digital sensing data; and
a multiplexer circuit configured to selectively connect the reference voltage application node and the analog-to-digital conversion circuit to the reference line.

17. The display system of claim 11, wherein the first routing metal and the second routing metal are formed using a metal on the same layer among a plurality of stacked layers.

18. The display system of claim 11, wherein the source driver integrated circuit further includes a first electrostatic discharge (ESD) diode configured to prevent an inflow of excessive current,
wherein the first resistance variation compensation circuit is connected between the first channel driving circuit and the first ESD diode.

19. The display system of claim 11, wherein the source driver integrated circuit further includes a second electrostatic discharge (ESD) diode configured to prevent an inflow of excessive current,
wherein the second resistance variation compensation circuit is connected between the second channel driving circuit and the second ESD diode.

20. The display system of claim 11, wherein the first resistance variation compensation circuit and the second resistance variation compensation circuit further include an electrostatic discharge (ESD) resistor having the same resistance value.
